(19) United States
(12) Patent Application Publication
(10) Pub. No.: US 2019/0064769 A1
(43) Pub. Date: Feb. 28, 2019

(54) METHOD, APPARATUS, DEVICE AND SYSTEM FOR GENERATING OPERATION SIMULATION INFORMATION OF NUMERICAL CONTROL DEVICE

(71) Applicant: Siemens Aktiengesellschaft, Muenchen (DE)

(72) Inventors: Chao REN, Shanghai (CN); Feng Ke SHE, Beijing (CN)

(73) Assignee: Siemens Aktiengesellschaft, Muenchen (DE)

(21) Appl. No.: 16/114,316

(22) Filed: Aug. 28, 2018

(30) Foreign Application Priority Data
Aug. 30, 2017 (CN) 2017 1 0763759.9

(51) Int. Cl. G05B 19/4069; G05B 19/4063; G05B 19/4065; G06F 3/0481

(52) U.S. Cl. CPC G05B 19/4069; G06F 3/04815; G05B 19/4065; G05B 19/4063

(57) ABSTRACT

The present application provides a method for generating operation simulation information of a numerical control device. The method includes: acquiring physical operation information of the numerical control device; acquiring model information corresponding to the numerical control device; generating operation simulation information of the numerical control device based upon the physical operation information and the model information, and outputting the operation simulation information to a client. Embodiments of the application have the advantage that it enables a remote user to see detailed information in a numerical control device operation process, such as a machining workpiece, a cutting tool and an operation procedure, in a visually direct way. This facilitates remote management of a factory by the user.

### PRIORITY STATEMENT

The present application hereby claims priority under 35 U.S.C. § 119 to Chinese patent application number CN 201710763759.9 filed Aug. 30, 2017, the entire contents of which are hereby incorporated herein by reference.

### FIELD

At least one embodiment of the present invention relates to the field of digital factories, in particular to a method, apparatus, device and system for generating operation simulation information of a numerical control device.

### BACKGROUND

To a person who is not present at a factory site, Computer Numerical Control (CNC) production processes are still not sufficiently transparent. In the prior art, field data must generally be acquired manually, or by online monitoring by sensors. However, in general, information acquired in such ways has a slow response, and explanations of the on-site conditions in the factory are few in number. The lack of real-time, precise field information will have a major impact on the efficiency and flexibility of product management.

Referring to FIG. 1, currently, a numerical control device 200 can communicate with an external device via a numerical control device controller 210. An existing online monitoring system mainly comprises two parts, namely: operation information collection and operation result visualization. For instance, the CNC controller 210 can send device state information of the numerical control device 200 corresponding thereto, such as a currently cutting state or an operation shutdown state, to a processing apparatus 001, and the processing apparatus 001 then converts the device state information to visual operation result information which is outputted to a client 300, e.g. a computer display screen.

However, the visual result information referred to here is generally only value information of certain key indices, e.g. number of workpieces, machine utilization rate, machine historical states, etc. A user is unable to obtain more visually direct and detailed information, such as a processing process of a workpiece, which components of the numerical control device perform the processing thereof, etc.

### SUMMARY

In view of the above, one of the problems solved by an embodiment of the present invention is the generation of operation simulation information of a numerical control device, to provide real-time, precise physical operation information for a person who is not on-site.

According to an embodiment of the method of the present invention, a method for generating operation simulation information of a numerical control device 200 is provided, the method comprising:
acquiring physical operation information of the numerical control device; and
acquiring model information corresponding to the numerical control device;
generating operation simulation information of the numerical control device on the basis of the physical operation information and the model information, and outputting the operation simulation information to a client.

Compared with the prior art, in the solution according to this embodiment, a remote user is enabled to see detailed information in a numerical control device operation process, such as a machining workpiece, a cutting tool and an operation procedure, in a visually direct way. This facilitates remote management of a factory by the user.

According to an embodiment of the method of the present invention, the model information comprises computer model information of the numerical control device and of an operation object thereof.

In the solution according to this embodiment, since model information of the numerical control device and of an operation object thereof is acquired, not only can simulation information of the numerical control device itself be generated, but overall operation simulation information can also be generated on the basis of an operation performed by the numerical control device on an operation object such as a workpiece.

According to an embodiment of the method of the present invention, the method further comprises:
acquiring time information corresponding to the physical operation information,
wherein generating and outputting operation simulation information further comprises:
   receiving designated time information from the client; and
   generating operation simulation information corresponding to the designated time information and outputting the operation simulation information to the client.

The solution according to this embodiment not only enables real-time operation simulation information to be presented, but also enables a user to designate a time, so as to generate corresponding operation simulation information on the basis of historical data corresponding to the time designated by the user, thereby enabling the user to view operation simulation information within the designated time.

According to an embodiment of the method of the present invention, the outputting to the client further comprises:
outputting the operation simulation information in the form of virtual reality data to the client.

The solution according to this embodiment can provide a virtual reality experience for the user, so that the user has a more authentic experience of the operating scenario of the numerical control device, and the degree to which the operating scenario is restored to its original condition is increased.

According to an embodiment of the method of the present invention, the physical operation information comprises at least either one of the following types of information:
component basic information; or
component operation information.

According to an embodiment of the present invention, a simulation apparatus for generating operation simulation information of a numerical control device in a numerical control system is provided, the simulation apparatus comprising:
a first acquisition unit, configured to acquire physical operation information of the numerical control device;
a second acquisition unit, configured to acquire model information corresponding to the numerical control device; and
an output unit, configured to generate operation simulation information of the numerical control device on the basis of the physical operation information and the model information, and output the operation simulation information to a client.

Compared with the prior art, in the solution according to this embodiment, a remote user is enabled to see detailed information in an operation process of the numerical control device 200, such as a machining workpiece, a cutting tool and an operation procedure, in a visually direct way. This facilitates remote management of a factory by the user.

According to an embodiment of the simulation apparatus of the present invention, the model information comprises computer model information of the numerical control device and of an operation object thereof.

In the solution according to this embodiment, since model information of the numerical control device and of an operation object thereof is acquired, not only can simulation information of the numerical control device itself be generated, but overall operation simulation information can also be generated on the basis of an operation performed by the numerical control device 200 on an operation object such as a workpiece.

According to an embodiment of the simulation apparatus of the present invention, the simulation apparatus further comprises:
a third acquisition unit, configured to acquire time information corresponding to the physical operation information,
wherein the output unit further comprises:
   a receiving unit, configured to receive designated time information from the client;
   a sub-generating unit, configured to generate operation simulation information corresponding to the designated time information and output the operation simulation information to the client.

The solution according to this embodiment not only enables real-time operation simulation information to be presented, but also enables a user to designate a time, so as to generate corresponding operation simulation information on the basis of historical data corresponding to the time designated by the user, thereby enabling the user to view operation simulation information within the designated time.

According to an embodiment of the simulation apparatus of the present invention, the output unit is further configured to:
output the operation simulation information in the form of virtual reality data to the client.

The solution according to this embodiment can provide a virtual reality experience for the user, so that the user has a more authentic experience of the operating scenario of the numerical control device, and the degree to which the operating scenario is restored to its original condition is increased.

According to an embodiment of the simulation apparatus of the present invention, the physical operation information comprises at least either one of the following types of information:

physical component information; or

component operation information.

According to an embodiment of the present invention, a computer device for generating operation simulation information of a numerical control device is provided, wherein the computer device comprises the simulation apparatus.

According to an embodiment of the present invention, a numerical control system is provided, comprising a numerical control device, a simulation apparatus, a model provision apparatus and at least one client, the numerical control device comprising a controller, wherein:
the controller of the numerical control device acquires physical operation information of the numerical control device;
the controller sends the physical operation information to the simulation apparatus;
the simulation apparatus receives the physical operation information;
the simulation apparatus acquires model information corresponding to the numerical control device;
the simulation apparatus generates operation simulation information on the basis of the physical operation information and the model information and outputs the operation simulation information to the client; and
the client receives and presents the operation simulation information.

In the solution according to this embodiment, simulation information of an on-site operating scenario of a digital factory can be provided for a remote user, so as to provide a basis for the user to understand and manage the operation and operational details of a factory. Moreover, the solution can be applied in many scenarios. For example, it may be used for tracking machine faults, training operating personnel, monitoring the production of products, and for production planning and control optimization. Clearly, the solution based on this embodiment can provide convenience for many implementation scenarios.

According to an embodiment of the present invention, a computer-readable medium is provided, on which is stored an executable instruction, characterized in that the executable instruction, when executed, realizes the method described in a preceding embodiment.

### BRIEF DESCRIPTION OF THE ACCOMPANYING DRAWINGS

Other features, characteristics, advantages and benefits of the present invention will become more obvious through the following detailed description which makes reference to the accompanying drawings.

FIG. 1 is a schematic structural diagram of a system in the prior art for acquiring operation result information of a numerical control device 200.

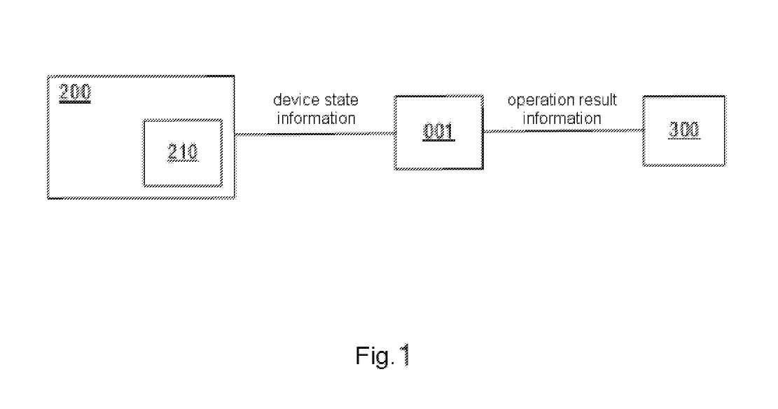

FIG. 2 is a schematic structural diagram of a system for generating operation simulation information of a numerical control device 200 according to an embodiment of the present invention.

FIG. 3 shows schematically a schematic structural diagram of a simulation apparatus 100 according to an embodiment of the present invention.

FIG. 4 is a general structural block diagram of a simulation apparatus 100 realized by hardware according to an embodiment of the present invention.

List of labels used in the drawings:

| | | | |
|---|---|---|---|
| 001 | processing | 100 | simulation |
| | apparatus | | apparatus |
| 101 | first acquisition | 102 | second |
| | unit | | acquisition unit |
| 103 | output unit | 200 | numerical control |
| 210 | controller | | device |
| 400 | model provision | 300 | client |
| | apparatus | 110 | memory |
| 120 | processor | | |

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or porcessors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (procesor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Preferred embodiments of the present disclosure are described in more detail below with reference to the accompanying drawings. Although the drawings illustrate preferred embodiments of the present disclosure, it should be understood that the present disclosure may be realized in various forms, and should not be restricted by the embodiments expounded here. On the contrary, these embodiments are provided in order to make the present disclosure more thorough and complete, and to completely convey the scope of the present disclosure to those skilled in the art.

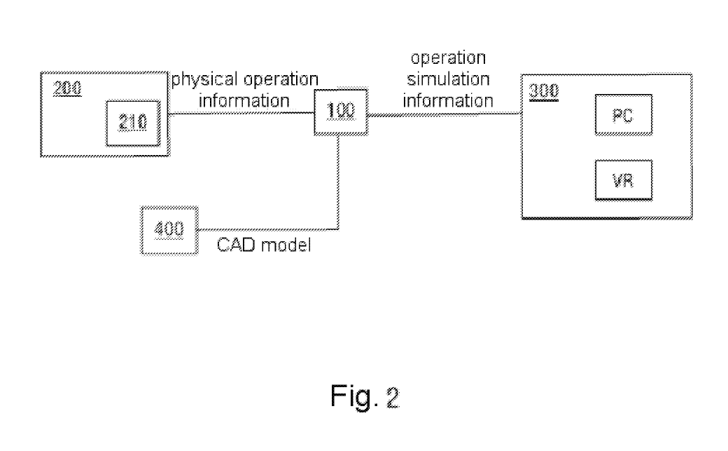

Reference is made to FIG. 2, which is a schematic system structure diagram of a numerical control system for generating operation simulation information of a numerical control device according to an embodiment of the present invention.

The numerical control system according to this embodiment comprises a simulation apparatus 100, a numerical control device 200, a client 300 and a model provision apparatus 400, wherein the numerical control device further comprises a controller 210.

The simulation apparatus 100 is used for generating operation simulation information corresponding to physical operation information of the numerical control device 200. The operation simulation information may be digital simulation information (which may also be called a digital twin) corresponding to physical operation information of the numerical control device.

The controller 210 of the numerical control device 200 acquires physical operation information of the numerical control device 200; and sends the physical operation information of the numerical control device 200 to the simulation apparatus 100.

In the present invention, the physical operation information of the numerical control device 200 may be parameter information associated with structures and movements of various components involved when the numerical control device 200 is performing operations. Preferably, the physical operation information further comprises parameter information associated with a structure and movement of a component of an operation object of the numerical control device.

The component is a part of the numerical control device, and is formed of at least one element.

The physical operation information comprises but is not limited to any one of the following types of information:
1) component basic information; e.g. component name, component model number, etc.
2) component operation information; e.g. component relative position information; component movement information, such as movement speed, rotation speed, etc.

For instance, in the case of a numerical control device used for a cutting operation, the component basic information thereof comprises cutter serial number information and cutter structure information; the component operation information thereof comprises information about axial position, spindle rotation speed, feeding speed and cutting torque, etc.

The simulation apparatus 100 acquires the physical operation information of the numerical control device CNC, and acquires model information corresponding to the numerical control device 200 from the model provision apparatus 400.

The model provision apparatus 400 is used for providing, to the simulation apparatus 100, model information of various components associated with operation of the numerical control device 200.

The model provision apparatus 400 according to the present invention may be located in a different device from the simulation apparatus 100, e.g. located in another server or personal computer which is different from the device to which the simulation apparatus 100 belongs, or may be located in the same device as the simulation apparatus 100, e.g. located on the same server.

The model information of the component comprises a model corresponding to each component in the numerical control device; preferably, the model information comprises a model of a key component in the numerical control device, e.g. spindle, linear axle, clamping, etc.

Preferably, the model information comprises model information of the numerical control device 200 and an operation object thereof.

The model provided by the model provision apparatus 400 may for example be a CAD model, e.g. a CAD 2D model or 3D model. Preferably, the model provision apparatus 400 may provide a corresponding 2D or 3D model on the basis of selection information of a user for a 2D model or 3D model.

Next, the simulation apparatus 100 generates operation simulation information of the numerical control device on the basis of the physical operation information and the model information and outputs the operation simulation information to the client 300; the client 300 receives and presents the operation simulation information.

Specifically, the simulation apparatus 100 can, on the basis of the obtained physical operation information and model information, drive the model of the numerical control device 200 to execute an operation corresponding to the physical operation information, and generate operation simulation information, so as to realize visual simulation of operation of the numerical control device 200, and output the operation simulation information obtained by simulation to the client 300.

The operation simulation information can be presented to the user in a visual form, such as an image or moving picture corresponding to the physical operation information of the numerical control device. More preferably, the simulation apparatus 100 may use a data form based on virtual reality technology to output the operation simulation information, to enable the user to obtain the visual information by the method of virtual reality.

The client 300 may comprise a terminal device capable of presenting the operation simulation information to the user in a visual form. Examples are a personal computer, smart phone or virtual reality device, etc.

Preferably, the simulation apparatus 100 can output the operation simulation information to multiple clients 300 simultaneously. For example, referring to FIG. 2, the simulation apparatus 100 may selectively output information to a personal computer (PC) and a mobile digital device, or to a virtual reality device (VR); or the simulation apparatus 100 may output to a PC and a VR simultaneously, for viewing by users of the two clients 300.

According to a preferred embodiment of the present invention, for example, a simulation apparatus 100 located on an independent server is connected to a numerical control device 200; the numerical control device 200 is a cutting tool equipped with a cutter. The simulation apparatus 100 obtains physical operation information of the numerical control device 200, comprising: axial position of a machine tool spindle, spindle rotation speed, cutter serial number, feeding speed, cutting torque, etc. Next, the simulation apparatus 100 acquires, from a model provision apparatus 400 located at another communicable device, CAD 3D model information corresponding to the numerical control device 200, e.g. 3D models of components such as a spindle, linear axle, clamping, cutting tool, product being cut, etc. On the basis of the physical operation information obtained, the simulation apparatus 100 drives the cutting machine model information obtained to execute an operation corresponding to the real cutting machine, to obtain operation simulation information for the cutting machine, generates a VR (virtual reality) device-readable form therefrom, and outputs this to a VR device terminal 300, to enable a user to view, via VR spectacles, the operation simulation information simulating a cutting process of the numerical control device. Of course, when a client device 300 is a mobile device, such as a smart phone or a tablet, the simulation apparatus 100 could also output the operation simulation information to a mobile digital device in a visual format, for example by local area network, Ethernet or mobile communication network, etc.

Preferably, the simulation apparatus 100 may perform simulation and output on the basis of real-time data, or the simulation apparatus may receive designated time information from the client 300, and perform simulation and output on the basis of physical operation information corresponding to the designated time information and model information of a corresponding component.

The designated time information is a time inputted or selected by a user. It may be a point in time, or a period of time.

For example, the user may input a period of time: Jan. 1, 2017, 10:00-11:00, to view operation simulation information of a numerical control device within this period of time.

Correspondingly, the simulation apparatus 100 may at the same time acquire time information corresponding to the physical operation information, in order to generate, upon receipt of designated time information from the client 300, operation simulation information corresponding to the designated time information and output the operation simulation information to the client 300.

The time information is a time when the numerical control device 200 executes an operation corresponding to physical operation information. It may be a point in time, or a period of time.

For instance, a spindle of a numerical control machine tool maintains rotation at a first speed from 11:30 to 11:35, and rotates at a second speed from 11:36 to 11:45; supposing that all other parameters remain unchanged, in this case the physical operation information obtained by a controller of the numerical control machine tool comprises the first speed and time information “11:30-11:35” corresponding thereto, and the second speed and time information “11:36 to 11:45” corresponding thereto.

Specifically, the simulation apparatus 100 can store physical operation information and model information on the basis of corresponding time information, and upon obtaining designated time information, perform a query on the basis of the designated time information, so as to obtain physical operation information corresponding to the designated time information and model information corresponding thereto, and on this basis generate operation simulation information corresponding to the designated time information, and output the operation simulation information to the client 300; or the simulation apparatus 100 generates operation simulation information on the basis of physical operation information and model information obtained, then stores the operation simulation information on the basis of corresponding time information, and upon obtaining designated time information, performs a query on the basis of the designated time information in order to obtain corresponding operation simulation information, and outputs the operation simulation information to the client 300.

It must be explained that the numerical control device used for cutting here is merely an example; the solution according to the present invention may be applied to numerical control devices with various functions, e.g. a numerical control device with a welding function, etc. There is no restriction to the numerical control device used for cutting which is given as an example here. Those skilled in the art will understand that information items contained in respective physical operation information of different numerical control devices might differ, but can all be obtained via the controller 210 corresponding to each numerical control device 200; no further description is provided superfluously here.

Preferably, the simulation apparatus 100 according to the present invention may be combined with an existing processing apparatus 001, to output operation result information and operation simulation information together to the client 300 after acquiring device state information and physical operation information.

According to the solution of an embodiment of the present invention, detailed information in a numerical control device operation process, such as a machining workpiece, a cutting tool and an operation procedure, can be seen in a visually direct way. Furthermore, an embodiment of the present invention not only enables real-time operation simulation information to be presented, but also enables a user to designate a time, so as to generate corresponding operation simulation information on the basis of historical data corresponding to designated time information of the user, thereby enabling the user to view operation simulation information corresponding to a point in time or period of time corresponding to the designated time information; thus, the present invention has a greater number of application scenarios. For example, it may be used for tracking machine faults, training operating personnel, monitoring the production of products, and for production planning and control optimization. Clearly, the solution based on the present invention can be flexibly applied in various scenarios, and provides convenience for many implementation scenarios.

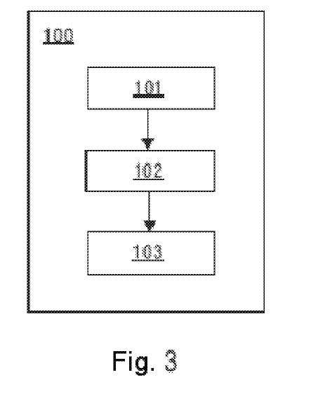

FIG. 3 shows schematically a schematic structural diagram of a simulation apparatus 100 according to an embodiment of the present invention.

The simulation apparatus 100 according to this embodiment comprises: a first acquisition unit 101, configured to acquire physical operation information of the numerical control device; a second acquisition unit 102, configured to acquire model information corresponding to the numerical control device; an output unit 103, for generating, on the basis of the physical operation information and the model information, operation simulation information of the numerical control device 200 and outputting the operation simulation information to a client 300.

The simulation apparatus 100 according to a preferred embodiment of the present invention further comprises: a third acquisition unit (not shown), configured to acquire time information corresponding to the physical operation information, wherein the output unit 103 further comprises: a receiving unit (not shown), configured to receive designated time information from the client 300; and a sub-generating unit (not shown), configured to generate operation simulation information corresponding to the designated time information and output the operation simulation information to the client 300.

The devices, apparatuses and units according to embodiments of the the present invention may be realized using software, hardware (e.g. integrated circuits, FPGA, etc) or a combination of software and hardware. In particular, the simulation apparatus 100 may be realized by hardware, such as an integrated circuit or a programmable gate array (FPGA), or realized by software configured in a computer device, etc.

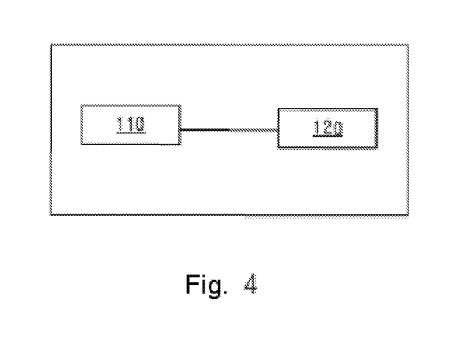

Reference is now made to FIG. 4, which shows a general structural block diagram of a simulation apparatus 100 realized by hardware according to an embodiment of the present invention. The simulation apparatus 100 may comprise a memory 110 and a processor 120. An executable instruction may be stored in the memory 110. The processor 120 may realize an operation executed by each unit of the simulation apparatus 100, according to the executable instruction stored in the memory 110.

In addition, also provided in an embodiment of the present invention is a machine-readable medium, on which is stored an executable instruction which, when executed, causes a machine to execute an operation realized by the simulation apparatus 100.

Those skilled in the art should understand that various changes in form and alterations may be made to the embodiments disclosed above without deviating from the substance of the invention. Thus, the scope of protection of the present invention shall be defined by the attached claims.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for generating operation simulation information of a numerical control device, comprising:
acquiring physical operation information of the numerical control device; and
acquiring model information corresponding to the numerical control device;
generating operation simulation information of the numerical control device based upon the physical operation information acquired and the model information acquired; and
outputting the operation simulation information generated to a client.

2. The method of claim 1, wherein the model information includes a computer model of the numerical control device and of an operation object of the numerical control device.

3. The method of claim 1, further comprising:
acquiring time information corresponding to the physical operation information acquired, wherein the generating and outputting operation simulation information further comprises:
receiving designated time information from the client;
generating operation simulation information corresponding to the designated time information received; and
outputting the operation simulation information generated to the client.

4. The method of claim 1, wherein the physical operation information comprises at least one of:
component basic information; and
component operation information.

5. The method of claim 1, wherein the outputting of the operation simulation information generated to the client further comprises:
outputting the operation simulation information generated in a form of virtual reality data to the client.

6. A simulation apparatus for generating operation simulation information of a numerical control device in a numerical control system, the simulation apparatus comprising:
a first acquisition unit, configured to acquire physical operation information of the numerical control device;
a second acquisition unit, configured to acquire model information corresponding to the numerical control device; and
an output unit, configured to generate operation simulation information of the numerical control device based upon the physical operation information acquired and the model information acquired, and configured to output the operation simulation information generated to a client.

7. The simulation apparatus of claim 6, wherein the model information comprises a computer model of the numerical control device and of an operation object of the numerical control device.

8. The simulation apparatus of claim 6, further comprising:
a third acquisition unit, configured to acquire time information corresponding to the physical operation information,
wherein the output unit further comprises:
a receiving unit, configured to receive designated time information from the client;
a sub-generating unit, configured to generate operation simulation information corresponding to the designated time information and configured to output the operation simulation information generated to the client.

9. The simulation apparatus of claim 6, wherein the physical operation information comprises at least one of:
component basic information; and
component operation information.

10. The simulation apparatus of claim 6, wherein the output unit is further configured to:
output the operation simulation information in a form of virtual reality data to the client.

11. A computer device for generating operation simulation information of a numerical control device, the computer device comprising the simulation apparatus of claim 6.

12. A numerical control system, comprising:
a numerical control device;
a simulation apparatus;
a model provision apparatus; and
at least one client, the numerical control device including a controller, wherein:
the controller of the numerical control device is configured to acquire physical operation information of the numerical control device;
the controller is configured to send the physical operation information to the simulation apparatus;
the simulation apparatus is configured to receive the physical operation information;
the simulation apparatus is configured to acquire model information corresponding to the numerical control device;
the simulation apparatus is configured to generate operation simulation information based upon the physical operation information and the model information and is configured to output the operation simulation information to the client;
the client is configured to receive and present the operation simulation information.

13. A non-transitory computer-readable medium, storing an executable instruction, the executable instruction, when executed, realizing the method of claim 1.

14. The method of claim 2, further comprising:
acquiring time information corresponding to the physical operation information acquired, wherein the generating and outputting operation simulation information further comprises:
receiving designated time information from the client;
generating operation simulation information corresponding to the designated time information received; and
outputting the operation simulation information generated to the client.

15. The method of claim 2, wherein the physical operation information comprises at least either one of:
component basic information; and
component operation information.

16. The method of claim 2, wherein the outputting of the operation simulation information generated to the client further comprises:
outputting the operation simulation information generated in a form of virtual reality data to the client.

17. The simulation apparatus of claim 7, further comprising:
a third acquisition unit, configured to acquire time information corresponding to the physical operation information,
wherein the output unit further comprises:
a receiving unit, configured to receive designated time information from the client;
a sub-generating unit, configured to generate operation simulation information corresponding to the designated time information and configured to output the operation simulation information generated to the client.

18. The simulation apparatus of claim 7, wherein the physical operation information comprises at least one of:
component basic information; and
component operation information.

19. A non-transitory computer-readable medium, storing an executable instruction, the executable instruction, when executed, realizing the method of claim 1.

20. A non-transitory computer-readable medium, storing an executable instruction, the executable instruction, when executed, realizing the method of claim 3.
